(19) United States
(12) Patent Application Publication
(10) Pub. No.: US 2008/0232485 A1
(43) Pub. Date: Sep. 25, 2008

(54) Method and system for improved power loading by steering and power loading the preamble in beamforming wireless communication systems

(75) Inventors: Huaning Niu, Sunnyvale, CA (US); Chiu Ngo, San Francisco, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/726,261

(22) Filed: Mar. 21, 2007

(51) Int. Cl. H04K 1/10

(52) U.S. Cl. 375/260

(57) ABSTRACT

A power-loading process for wireless communications is provided. The power-loading process includes parsing data into multiple spatial data streams, beam-steering the spatial data streams and a preamble with both a power loading level and channel eigenvalues, for transmission over a plurality of transmission antennas at a wireless transmitter. The process further includes receiving the transmission streams via receive antennas at a wireless receiver and estimating each equivalent channel based on the received preamble to obtain the CSI. The obtained CSI includes the transmitter power loading information for the receiver. The receiver utilizes the power loading information in the obtained CSI, eliminating the need for the detecting power loading from pilot tones at the receiver.

### FIELD OF THE INVENTION

The present invention relates generally to wireless communications, and in particular to IEEE 802.11n multiple-input-multiple-output (MIMO) wireless communication systems.

### BACKGROUND OF THE INVENTION

In the field of wireless communications, MIMO is one of the promising schemes for achieving spatial diversity to increase system link robustness and spectral efficiency. The basic idea of spatial diversity is that multiple antennas are less likely to fade simultaneously compared to a single antenna element. Diversity techniques increase the average signal-to-noise-ratio (SNR) by means of coherent combining. Space-time coding is a particularly attractive approach to realize transmit-diversity gain without requiring channel knowledge at the transmitter. Another type of diversity scheme is delay diversity, where each transmitter antenna sends a delayed version of the same signal that can be readily exploited through the use of coded orthogonal frequency division multiplexing (OFDM).

Existing approaches for optimizing spectral efficiency for MIMO systems can be broadly classified into two categories: open-loop approaches and closed-loop approaches. The open-loop approach includes spatial multiplexing, space-time coding, and the tradeoffs between them. The closed-loop approach focuses on maximizing the link capacity, which results in a “water-filling” solution, and minimizing the weighted minimum mean-squared error (MMSE), which provides an “inverse water-filling” solution.

In an open-loop MIMO system comprising a transmitter and one or more receivers, the transmitter has no prior knowledge of the channel condition (i.e., channel state information (CSI)). As such, space-time coding techniques are usually implemented in the transmitter to combat fading channels. In a closed-loop MIMO system, the CSI can be fed back to the transmitter from a receiver, wherein some pre-processing can be performed at the transmitter, in order to separate the transmitted data streams at the receiver side. Such techniques are referred to as beamforming techniques, which provide better performance in a desired receiver's direction and suppress the transmit power in other directions.

Beamforming techniques are considered for the IEEE 802.11n (high throughput wireless local area network (WLAN)) standard. Closed-loop eigen-beamforming generally provides higher system capacity compared with the open-loop approach which assumes the transmitter has knowledge of the down-link channel information. Singular vector decomposition (SVD) based eigen-beamforming decomposes the correlated MIMO channel into multiple parallel pipes.

FIG. 1 shows a functional block diagram of a transmitter 10 in a MIMO IEEE 802.11n wireless communication system based on the TGn Sync specification (S. A. Mujtaba, “TGn Sync Proposal Technical Specification,” a contribution to IEEE 802.11, 11-04-889r0, August 2004, incorporated herein by reference).

The transmitter 10 comprises: a scrambler/forward error correction (FEC) function 14, a parser 16, multiple (Nₛₛ) interleaver/quadrature amplitude modulation (QAM) mapping modules 18, a power loading function 20, a beam-steering function 22, multiple (Nₜ) stream processors 24, and multiple (Nₜ) transmit antennas 26.

The scrambler/FEC function 14 encodes incoming physical layer convergence protocol (PLCP) service data unit (PSDU) bits 12. The parser 16 generates Nₛₛ spatial streams from the encoded bits. The interleaving functions of the modules 18 reshuffle the encoded bits across the OFDM spectrum to improve diversity. The QAM mapping functions of the modules 18 group/map the interleaved bits into symbols using a Gray Mapping Rule. The power loading function 20 loads different powers in each spatial data stream according to selected power loading schemes to generate a power-loaded data stream. The beam-steering function 22 performs steering of data and the HT preamble 11 using a beamforming matrix V to generate Nₜ transmit antenna streams.

The signaling preamble 11 is not power-loaded before beam-steering. Each stream processor 24 operates on each transmit antenna stream by applying: inverse FFT (iFFT), guard interval (GI) window insertion, digital-to-analog conversion, and radio frequency (RF) conversion, as is known to those skilled in the art. In this manner, Nₛₛ number of data streams are generated for transmission over Nₜ transmit antennas to Nᵣ receive antennas (Nₛₛ<Min(Nᵣ, Nₜ)).

When applying the closed-loop approach for optimizing spectral efficiency to a MIMO-OFDM protocol, such as implemented by the transmitter 10 above, the optimal solution requires a bit-loading and power loading per OFDM subcarrier. Bit-loading and power loading are adaptive (simultaneously) per subcarrier, per Nₛₛ×1 transmitted signal vector, and per Nₛₛ×Nₛₛ diagonal matrix V with loading power αᵢ along the diagonal.

In order to reduce complexity, one conventional approach for spectral efficiency performance improvement involves bit-loading and power loading by adapting coding/modulation and power level across all subcarriers. As in other conventional approaches for spectral efficiency performance improvement, such a bit-loading and power loading approach is based on the assumption of no channel impairment. However, the spectral efficiency performance can be degraded by channel impairment, imperfect channel estimation, imperfect synchronization, etc. With power loading, the problem is magnified as cross-talk between different streams worsens with imperfect CSI. There is, therefore, a need for method and system for improved power loading by steering and power loading the preamble in beamforming wireless communication systems.

### BRIEF SUMMARY OF THE INVENTION

The present invention provide a method and system for improved power loading by steering and power loading the preamble in beamforming wireless communication systems. Improved power loading is achieved by first applying power loading to both a signaling preamble and to data, and then beam-steering the power-loaded preamble and the power-loaded data for transmission to a wireless receiver.

In one embodiment of improved power loading, a closed-loop signaling process includes the steps of parsing data into multiple spatial data streams and then beam-steering the spatial data streams and the preamble with both a power loading level and channel eigenvalues for transmission over a plurality of transmit antennas.

The signaling process further includes the steps of receiving the transmission streams via several receiver antennas at a wireless receiver, and estimating each equivalent channel based on the received preamble to obtain the CSI. The obtained CSI includes the transmitter power loading information for the receiver. The receiver utilizes the power loading information in the obtained CSI, thereby eliminating the need for detecting power loading from pilot tones at the receiver.

The present invention also provides a wireless system including a transmitter that implements the above signaling process to perform closed-loop signaling for data transmission to a wireless receiver via one or more wireless channels. In one embodiment, the wireless transmitter comprises a parser, a power loading module and a beamforming steering module. The parser parses data into multiple spatial data streams. The power loading module inputs the multiple spatial data streams and a signaling preamble, and applies power loading to the multiple spatial data streams and the signaling preamble, to generate a power-loaded stream. The beamforming steering module then steers the power-loaded stream by beamforming, to generate a plurality of transmission streams for transmission to the receiver over a corresponding plurality of transmitter antennas.

Preferably, the beamforming steering module further applies a beamforming matrix to the power-loaded stream to generate said plurality of transmission streams, thereby applying beam-steering to both the underlying power-loaded data and the underlying power-loaded preamble.

In one implementation, the wireless transmitter implements a type of IEEE 802.11n protocol, wherein said preamble comprises the high throughput long preamble (HT-LTF) of the high throughput signaling (HT-SIG) field in the IEEE 802.11n protocol. In that case, the beamforming steering module steers the HT-LTF with both a power level and channel eigenvectors.

The wireless system further includes a receiver that includes a channel estimator. The channel estimator is configured to estimate an equivalent channel based on the received HT-LTF of the HT-SIG field in the preamble to obtain the CSI. The obtained CSI at the receiver includes the transmitter power loading information for the receiver. The receiver utilizes the power loading information in the obtained CSI, rather than performing power loading detection based on pilot tones.

These and other features, aspects and advantages of the present invention will become understood with reference to the following description, appended claims and accompanying figures.

### BRIEF DESCRIPTION OF THE DRAWINGS

FIG. 1 shows a functional block diagram of a MIMO transmitter with power loading based on the IEEE 802.11n (TGn Sync) specification.

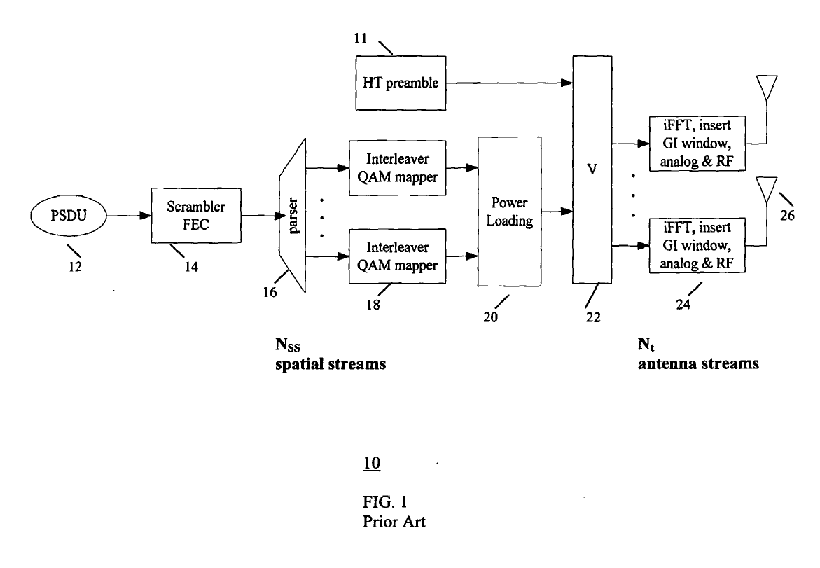

FIG. 2 shows a functional block diagram of a MIMO transmitter structure with a steered and power-loaded high throughput long training field (HT-LTF), according to an embodiment of the present invention.

FIG. 3 shows a functional block diagram of a MIMO receiver with a steered and power-loaded HT-LTF.

FIG. 4 shows a performance comparison between a MIMO system according to the present invention, and other MIMO systems.

FIG. 5 shows a performance comparison between a MIMO system according to the present invention, and other MIMO systems.

### DETAILED DESCRIPTION OF THE INVENTION

The present invention provides improved power loading for beamforming wireless transmission by first applying power loading to both a signaling preamble and to data, and then beam-steering the power-loaded preamble and the power-loaded data for transmission. In one embodiment, such power loading involves steering and power loading the signaling preamble for beamforming communication, such as MIMO beamforming communication implementing OFDM.

The IEEE 802.11n protocol defines a MIMO-OFDM beamforming wireless communication protocol in which the high throughput signaling field (HT-SIG) includes a HT preamble (i.e., HT-LTF) defined for high rate transmission. According to a preferred embodiment of the present invention that implements a type of IEEE 802.11n protocol, power loading is applied to both the data and to the HT long preamble (i.e., high throughput long training field or HT-LTF, before beam-steering for transmission over wireless channels is performed.

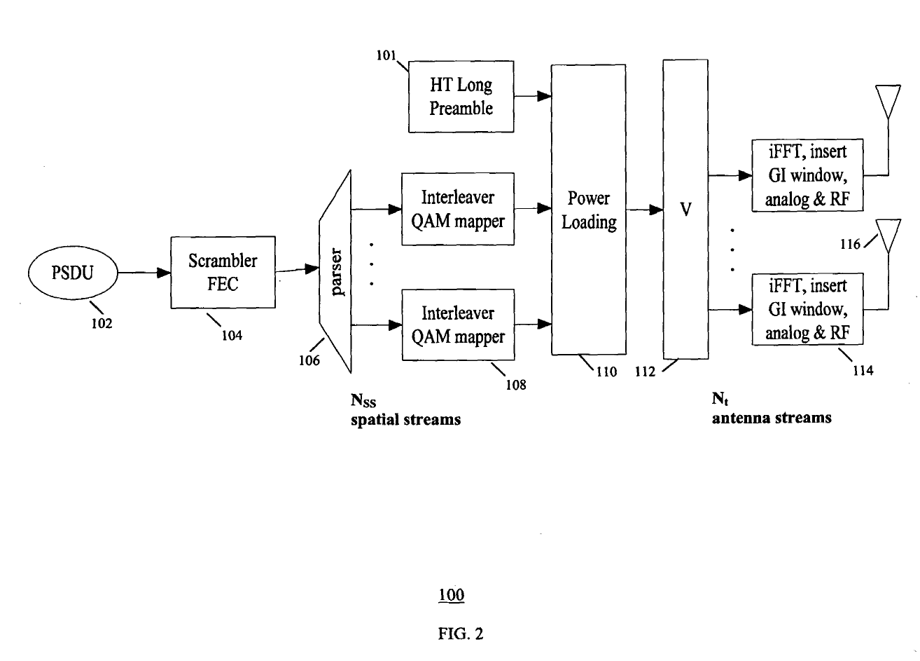

FIG. 2 shows a functional block diagram of a transmitter 100 in a MIMO wireless communication system, which implements improved power loading by power loading and steering the preamble for MIMO-OFDM beamforming, according to said preferred embodiment of the present invention.

The transmitter 100 comprises: a scrambler/FEC function 104, a parser 106, multiple (Nₛₛ) interleaver/QAM mapping modules 108, a power loading function 110, a beam-steering function 112, multiple (Nₜ) stream processors 114, and multiple (Nₜ) transmit antennas 116. The scrambler/FEC function 104 encodes incoming PSDU bits 102. The parser 106 generates Nₛₛ spatial streams from the encoded PSDU bits. The interleaving functions of the modules 108, reshuffle the encoded bits across the OFDM spectrum to improve diversity. The QAM mapping functions of the modules 108 group/map the interleaved bits into symbols using a Gray Mapping Rule. The power loading function 110 applies power loading to the HT preamble 101 of the HT-SIG field, and also loads different powers in each spatial stream to generate a power-loaded stream. The beam-steering function 112 then steers the power-loaded stream using a beamforming matrix V to generate Nₜ transmit antenna streams.

Each stream processor 114 operates on each transmit antenna stream by applying: inverse FFT (iFFT) processing, guard interval (GI) window insertion, digital-to-analog conversion, and base-band to RF conversion, as is known to those skilled in the art.

The power loading function 110 determines power loading per spatial data stream, and applies power loading to both the data (i.e., the spatial data streams) and to the HT long preamble (i.e., HT-LTF). As such, the beam-steering matrix V function 110 applies beam-steering to the power-loaded HT long preamble 101 and to the power-loaded spatial data streams for transmission via several channels over the transmit antennas 116.

In one example implementation, the transmitter 100 steers the power-loaded HT long preamble 101 and the power-loaded data streams, with both power level and channel eigenvectors. Related U.S. patent application Ser. No. 11/110,346, entitled “Power loading method and apparatus for throughput enhancement in MIMO systems,” filed Apr. 19, 2005 (incorporated herein by reference), provides an example of steering with the power level and the channel eigenvectors. A simplification is provided in Related U.S. patent application Ser. No. 11/321,267, entitled “Constant uneven power loading in beamforming systems for high throughput wireless communications,” filed Dec. 29, 2005 (incorporated herein by reference), which involves fixing coding/modulation and the power loading level for all OFDM symbols. Further, in Related U.S. patent application Ser. No. 11/314,928, entitled “Method and apparatus of constant-power loading for asymmetric antenna configuration,” filed Dec. 20, 2005 (incorporated herein by reference), an asymmetric antenna configuration is utilized to improve system performance.

By power loading both the data streams and the HT preamble 101 as described herein, power loading by the transmitter is effectively transparent to the receiver. Further, steering the power-loaded HT long preamble 101 and the power-loaded data streams makes power loading detection at the receiver unnecessary. Instead, the receiver estimates each channel using the HT long preamble. Such channel estimation only requires estimating the equivalent channel H′ at the receiver, as described further below.

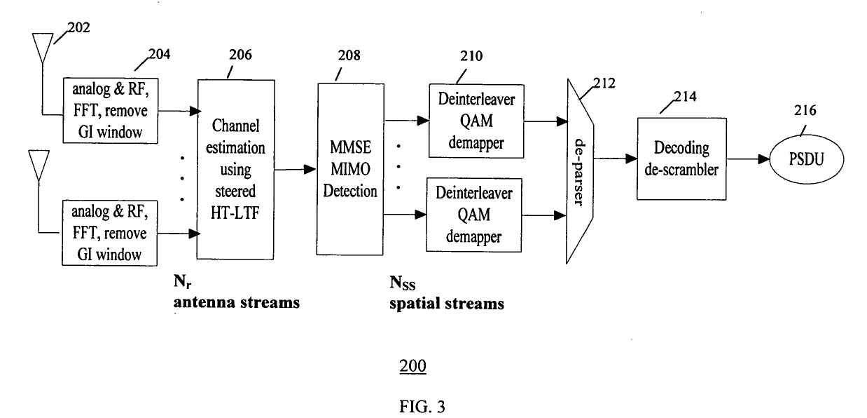

FIG. 3 shows a functional block diagram of an embodiment of a receiver 200 for receiving transmissions from the transmitter 100 of FIG. 2, according to an embodiment of the present invention. The receiver 200 can consist of a conventional MIMO receiver. There is no explicit inverse power loading block in the receiver structure since the power loading level is embedded in the channel estimation by applying power loading to the HT long preamble 101 at the transmitter 100.

In this embodiment, the receiver 200 includes: multiple (Nᵣ) receiver antennas 202, multiple (Nᵣ) stream processors 204, a channel estimator 206, a MMSE MIMO detector 208, multiple (Nₛₛ) deinterleaver QAM demapping modules 210, a de-parser 212, and a decoding de-scrambling module 214.

The multiple receiver antennas 202 receive the signals transmitted from the transmitter antennas 116 for processing by the multiple stream processors 204. The stream processors 204 provide reverse functionality of the stream processors 114 of the transmitter 100. Accordingly, each stream processor 204 processes a signal from a corresponding receiver antenna 202 by applying: RF to base-band conversion, analog-to-digital conversion, FFT processing and GI window removal, as is known to those skilled in the art. As such, the received signals are sampled and down-converted to Nᵣ base-band antenna stream digital signals.

The channel estimator 206 performs channel estimation using the HT-LTF of the HT long preamble from the Nᵣ base-band antenna stream digital signals. The channel estimator 206 estimates the equivalent channel H′, which provides an estimated CSI as discussed further below. The MMSE MIMO detector 208 generates Nₛₛ spatial streams based on the output of the channel estimator 206. The Nₛₛ spatial streams are processed by the Nₛₛ deinterleaving QAM demapping modules 210, for constellation de-mapping (i.e., de-mapping constellation points to soft bit information), and reshuffling the de-mapped soft bit information for decoding.

The de-parser 212 de-multiplexes the Nₛₛ data streams from the Nₛₛ deinterleaving QAM de-mapping modules 210 into one decoding stream for Viterbi decoding by the decoding/de-scrambling module 214 to generate a PSDU 216.

An example of estimating the equivalent channel H′ by the channel estimator 206 of the receiver 200 is now described. According to a preferred embodiment of the present invention, power loading at the transmitter loads different pre-calculated powers to the data (e.g., PSDU data bits) and the HT long preamble. Assuming the received HT long preamble at the receiver side is denoted as Y, then Y=HVP x+n, wherein x is the transmitted HT long preamble, P is a Nₛₛ×Nₛₛ diagonal matrix with loading power. αᵢ along the diagonal, V is the Nₜ×Nss right singular vector corresponding to the Nₛₛ largest eigenvalues, H is a Nᵣ×Nₜ channel response which can be factored using singular value decomposition (SVD) as H=U D V^{H}, and n is Nᵣ×1 additive noise vector in the channel.

A received signal (i.e., symbol) y at the receiver 200 can be represented as y=HVPx+n, wherein x is the Nₛₛ×1 transmitted signal vector, and n is Nᵣ×1 additive noise vector in the channel. The received signal is multiplied by a left singular vector matrix U^{H}, whereby the received signal after processing, Xₚ, at the receiver can be expressed as Xₚ=U^{H} y=DPx+U^{H} n.

The equivalent channel can then be estimated as by the channel estimator 206 of the receiver 200 by calculating H′=HVP=Y/x. The estimated equivalent channel H′ provides the estimated CSI. The estimated CSI provides power loading information which the receiver 200 can use to detect power loading, rather than detect power loading from pilot tones from the transmitter. Further, since the HT long preamble (HT-LTFs) is power-loaded and steered by the transmitter, then the CSI estimated by the receiver 100 is also the steered and power-loaded channel information. Therefore, there is no need to independently calculate the power level at the receiver.

According to the preferred embodiments of the present invention, a wireless transmitter implementing closed-loop signaling with power loading and beam-steering of both the preamble and the data, provides robust performance over fading channels even with channel impairment (without requiring additional processing at the receiver).

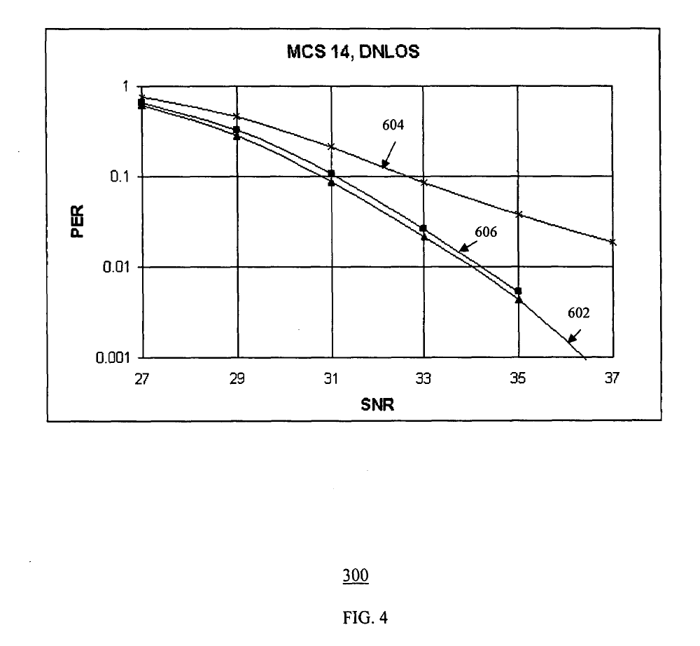

FIG. 4 shows a simulated performance comparison using modulation coding scheme (MCS) 14, for a MIMO wireless communication system (“MIMO system”) with power-loading, according to the preferred embodiments of the present invention versus a MIMO system with power level auto-detection at the receiver using pilot tones from the transmitter.

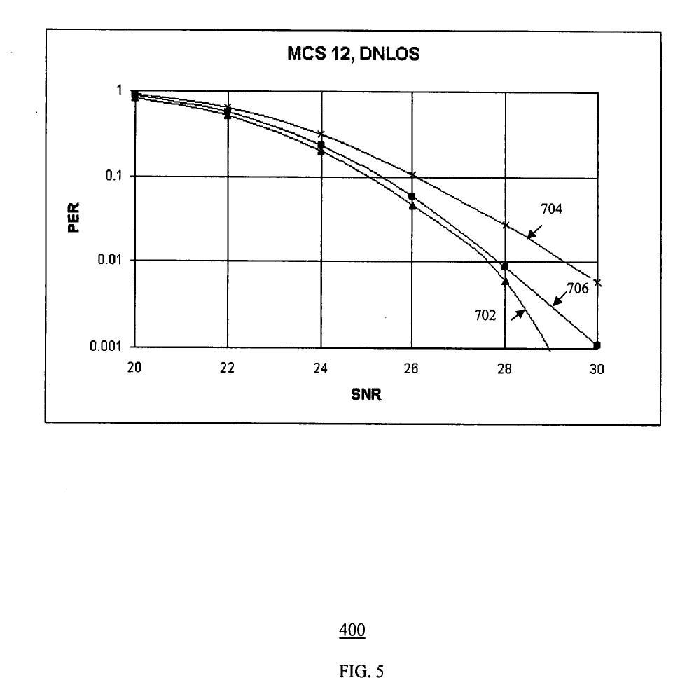

FIG. 5 shows a simulated performance comparison using MCS 12, for a MIMO system with power-loading according to the preferred embodiments of the present invention versus a MIMO system with power level auto-detection at the receiver using pilot tones from the transmitter.

In the examples in FIGS. 4 and 5, the following simulation settings were used:
A 2×2×20 MHz TGnSync system structure, Channel models: the IEEE 802.11n, over channel DNLOS,
Per-tone channel estimation;
1000 bytes packet, ensemble SNR,
MMSE detector with soft APP processing,
Convolutional codes: Viterbi decoding with 10 bits quantization and 128 trace-back length.

The example 300 in FIG. 4, maps packet error rate (PER) vs. SNR for MCS 14, wherein: (1) a graph 602 shows the performance of a MIMO system according to the preferred embodiments of the present invention, (2) a graph 604 shows the performance of a MIMO system with power level auto-detection at the receiver using pilot tones from the transmitter, and (3) a graph 606 shows the “idealized” performance of the MIMO system with power level auto-detection at the receiver using pilot tones from the transmitter, as a benchmark for comparison, where it is assumed that the power level is perfectly known at the receiver.

As FIG. 4 illustrates, the performance of a MIMO system with power level auto-detection at the receiver using pilot tones from the transmitter, as shown in graph 604, suffers about 1.5 dB degradation compared to the MIMO system in the corresponding graph 606. However, graph 602, corresponding to a MIMO system according to the preferred embodiments of the present invention, shows more robust performance in the face of channel impairment and achieves the best performance in a realistic system.

The example 400 in FIG. 5, maps PER vs. SNR for MCS 12, wherein: (1) a graph 702 shows the performance of a MIMO system according to the preferred embodiments of the present invention, (2) a graph 704 shows the performance of a MIMO system with power level auto-detection at the receiver using pilot tones from the transmitter, and (3) a graph 706 shows the “idealized” performance of a MIMO system with power level auto-detection at the receiver using pilot tones from the transmitter, as a benchmark for comparison, where it is assumed that the power level is perfectly known at the receiver. As FIG. 5 illustrates, performance of the MIMO system with power level auto-detection at the receiver using pilot tones from the transmitter, as shown on graph 704, suffers about 1.5 dB degradation in performance compared to the MIMO system corresponding to the graph 706. However, graph 702 corresponding to a MIMO system according to the preferred embodiments of the present invention, shows more robust performance in the face of channel impairment and achieves the best performance in a realistic system.

A MIMO system with power loading according to the preferred embodiments of the present invention, where the HT long preamble (i.e. HT-LTF) is steered with both the eigenvector and the power level, provides the best performance and the simplest receiver. In the instance where the receiver can only obtain the equivalent channel estimation instead of the exact CSI, which is used in rate adaptation, the rate adaptation should be based on the sounding packet from the receiver.

As is known to those skilled in the art, the aforementioned example architectures described above, according to the present invention, can be implemented in many ways, such as program instructions for execution by a processor, as logic circuits, as an application specific integrated circuit, as firmware, etc. The present invention has been described in considerable detail with reference to certain preferred versions thereof; however, other versions are possible. Therefore, the spirit and scope of the appended claims should not be limited to the description of the preferred versions contained herein.

What is claimed is:

1. A power-loading method in a wireless communication system, comprising the steps of:
closed-loop signaling by parsing data into multiple spatial data streams;
obtaining a signaling preamble; and
beam-steering the spatial data streams and the preamble with both a power loading level and channel eigenvalues, for transmission over a corresponding plurality of transmit antennas of a wireless transmitter.

2. The method of claim 1 wherein the beam-steering step further includes the steps of:
applying power loading to the preamble and the multiple spatial data streams to generate a power-loaded stream; and
generating a corresponding plurality of transmission streams from the power-loaded stream for transmission over the plurality of transmitter antennas.

3. The method of claim 2 wherein the step of generating a corresponding plurality of transmission streams further includes the step of applying a beam-steering matrix to the power-loaded stream for generating said corresponding plurality of transmission streams, thereby applying beam-steering to both the data and to the preamble.

4. The method of claim 3 further comprising the step of transmitting the transmission streams via several channels over multiple antennas.

5. The method of claim 4 wherein the wireless communication system implements a type of IEEE 802.11n protocol, and wherein said preamble comprises HT-LTFs.

6. The method of claim 5 further including the steps of:
receiving the transmission streams via receive antennas at a wireless receiver; and
estimating each equivalent channel based on the received HT-LTF to obtain the CSI.

7. The method of claim 6 wherein the obtained CSI includes the transmitter power loading information for the receiver.

8. The method of claim 1 wherein the wireless communication system comprises a MIMO system.

9. The method of claim 1 wherein:
the wireless communication system implements a type of IEEE 802.11n protocol, and said preamble comprises the HT-LTF; and
the step of steering further includes the step of beam-steering the HT-LTF with both the power level and the channel eigenvectors.

10. The method of claim 1 further comprising the steps of selectively determining the power loading at the transmitter.

11. A method of transmission power loading in a wireless communication system, comprising the steps of:
parsing data into multiple spatial data streams;
applying power loading to a preamble and the multiple spatial data streams to generate a power-loaded stream;
generating a corresponding plurality of transmission streams from the power-loaded stream for transmission over a corresponding plurality of transmitter antennas; and
transmitting the transmission streams via several channels over the plurality transmit antennas to a wireless transmitter.

12. The method of claim 11 wherein:
the wireless communication system comprises a MIMO system; and
the step of generating a plurality of transmission streams further includes the step of applying a beam-steering matrix to the power-loaded stream for generating said plurality of transmission streams, thereby applying beam-steering to both the data and to the preamble.

13. The method of claim 12 wherein the wireless communication system implements a type of IEEE 802.11n protocol, and wherein said preamble comprises HT-LTFs.

14. The method of claim 13 further including the steps of:
receiving the transmission streams via receive antennas at a wireless receiver; and
estimating each equivalent channel based on the received HT-LTF to obtain the CSI.

15. The method of claim 14 wherein the obtained CSI includes the transmitter power loading information for the receiver.

16. The method of claim 11 wherein:
the wireless communication system implements a type of IEEE 802.11n protocol, and said preamble comprises the HT-LTF; and
the step of steering further includes the step of beam-steering the HT-LTF with both the power level and the channel eigenvectors.

17. The method of claim 11 further comprising the step of selectively determining the power loading at the transmitter.

18. The method of claim 11 further including the steps of:
receiving the transmission streams via receive antennas at a wireless receiver; and
estimating each equivalent channel based on the received preamble to obtain the CSI.

19. The method of claim 18 wherein the obtained CSI includes the transmitter power loading information for the receiver.

20. The method of claim 19 wherein the receiver utilizes the power loading information in the obtained CSI, eliminating the need for detecting power loading from pilot tones at the receiver.

21. The method of claim 11 wherein the wireless communication system comprises a MIMO-OFDM wireless communication system.

22. A wireless communication system, comprising:
a wireless transmitter and a wireless receiver, wherein the transmitter performs closed-loop signaling for data transmission to the receiver via wireless channels, the transmitter comprising:
a parser that is configured to parse data into multiple spatial data streams;
a power loading module that is configured to input the multiple spatial data streams and a signaling preamble, and is configured to apply power loading to the multiple spatial data streams and the signaling preamble, to generate a power-loaded stream; and
a beamforming steering module that is configured to steer the power-loaded stream by beamforming to generate a corresponding plurality of transmission streams for transmission to the receiver over a corresponding plurality of transmitter antennas.

23. The system of claim 22 wherein the beamforming steering module is further configured to apply a beamforming matrix to the power-loaded stream to generate said plurality of transmission streams, thereby applying beam-steering to both the underlying power-loaded data and the underlying power-loaded preamble.

24. The system of claim 23 wherein the transmitter is configures to transmit the transmission streams via several channels over the multiple antennas.

25. The system of claim 24 wherein the transmitter and the receiver implement a MIMO-OFDM wireless communication protocol.

26. The system of claim 24 wherein the wireless receiver comprises: multiple receiver antennas configured to receive the transmission streams, and a channel estimator that is configured to estimate an equivalent channel based on the received HT-LTF in the preamble to obtain the CSI.

27. The system of claim 26 wherein the obtained CSI at the receiver includes the transmitter power loading information for the receiver.

28. The system of claim 22 wherein the wireless communication system implements a type of IEEE 802.11n protocol, and said preamble comprises the HT-LTF of the HT-SIG field in the IEEE 802.11n protocol.

29. The system of claim 28 wherein the beamforming steering module is further configured to steer the HT-LTF with both the power level and the channel eigenvectors.

30. The system of claim 22 wherein the power loading module is further configured to selectively determine the power loading.

31. A wireless transmitter for data transmission to a wireless receiver via one or more wireless channels, the wireless transmitter comprising:
a parser that is configured to parse data into multiple spatial data streams;
a power loading module configured to input the multiple spatial data streams and a signaling preamble, and to apply power loading to the multiple spatial data streams and the signaling preamble, to generate a power-loaded stream; and
a beamforming steering module that is configured to steer the power-loaded stream by beamforming to generate a plurality of transmission streams for transmission to the receiver over a corresponding plurality of transmitter antennas.

32. The wireless transmitter of claim 31 wherein the beamforming steering module is configured to apply a beamforming matrix to the power-loaded stream to generate said corresponding plurality of transmission streams, thereby applying beamforming steering to both the underlying power-loaded data and the underlying power-loaded preamble.

33. The wireless transmitter of claim 32 wherein the transmission streams are transmitted over several channels over the multiple antennas.

34. The wireless transmitter of claim 33 wherein said preamble comprises the HT-LTFs.

35. The wireless transmitter of claim 31 wherein the wireless transmitter comprises a MIMO-OFDM wireless transmitter.

36. The wireless transmitter of claim 31 wherein:
the wireless transmitter implements a type of IEEE 802.11n protocol, and said preamble comprises the HT-LTF; and
the beamforming steering module is further configured to steer the HT-LTF with both the power level and the channel eigenvectors.

37. The wireless transmitter of claim 31 wherein the power loading module is further configured to selectively determine the power loading.

38. A wireless receiver, comprising:
multiple receiver antennas configured to receive a transmission stream including a HT-LTF in a preamble; and
a channel estimator that is configured to estimate an equivalent channel based on the received HT-LTF in the preamble to obtain the CSI.

39. The receiver of claim 38 wherein the obtained CSI at the receiver includes transmission power loading information for the receiver.

40. The receiver of claim 39 wherein the receiver implements a type of IEEE 802.11n protocol, and said preamble comprises the HT-LTF of the HT-SIG field in the IEEE 802.11n protocol.

41. The receiver of claim 38 wherein the received HT-LTF is steered with both the power level and the channel eigenvectors.
